(19) United States
(12) Patent Application Publication
(10) Pub. No.: US 2009/0315688 A1
(43) Pub. Date: Dec. 24, 2009

(54) METHOD AND SYSTEM FOR PROCESSING AUDIO SIGNALS FOR HANDSET VIBRATION

(76) Inventors: Hongwei Kong, Denville, NJ (US); Liang Deng, San Jose, CA (US); Minsheng Wang, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 12/200,785

(22) Filed: Aug. 28, 2008

Related U.S. Application Data
(60) Provisional application No. 61/073,992, filed on Jun. 19, 2008.
(60) Provisional application No. 61/091,840, filed on Aug. 26, 2008.

(51) Int. Cl. H04B 3/36

(52) U.S. Cl. 340/407.1

(57) ABSTRACT

Aspects of a method and system for processing audio signals for handset vibration are provided. In this regard, an electronic device may control vibrations generated by a vibration transducer based on audio signals processed by the electronic device. The vibration transducer may be started and/or stopped based on the audio signal. For example, the vibration transducer may be controlled based on a rhythm and/or tempo of the audio signal and/or a content type of the audio signal. The electronic device may control a pattern and/or a frequency at which the transducer is started and/or stopped based on the audio signal. An intensity of generated vibrations may be varied based on the audio signal. A duration of the generated vibrations may be controlled based on the audio signal. The vibration transducer may be controlled based on an event occurring on the electronic device that triggered the processing of the audio signal.

### CROSS-REFERENCE TO RELATED APPLICATIONS/INCORPORATION BY REFERENCE

This patent application makes reference to, claims priority to and claims benefit from U.S. Provisional Patent Application Ser. No. 61/073,992 on Jun. 19, 2008.

This application also makes reference to U.S. Provisional Patent Application Ser. No. 61/091,840, filed on Aug. 26, 2008.

Each of the above stated applications is hereby incorporated herein by reference in its entirety.

### FIELD OF THE INVENTION

Certain embodiments of the invention relate to processing audio signals. More specifically, certain embodiments of the invention relate to a method and system for processing audio signals for handset vibration.

### BACKGROUND OF THE INVENTION

In audio applications, systems that provide audio interface and processing capabilities may be required to support duplex operations, which may comprise the ability to collect audio information through a sensor, microphone, or other type of input device while at the same time being able to drive a speaker, earpiece of other type of output device with processed audio signal. In order to carry out these operations, these systems may comprise audio processing devices that provide appropriate gain, filtering, analog-to-digital conversion, and/or other processing of audio signals in an uplink direction and/or a downlink direction. In the downlink direction, an audio processing device may condition and/or process baseband audio signals from a receiver for presentation via audio output devices such as a loudspeaker and headphones. In an uplink direction, an audio processing device may process and/or condition audio signals received from an input device such as a microphone and convey the processed signals to a transmitter. Existing audio processing devices are limited in their ability to support a variety of audio signal formats and/or a variety of audio input and/or output devices.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for processing audio signals for handset vibration, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary wireless system, which may be utilized in accordance with an embodiment of the invention.

FIG. 2 is a block diagram illustrating an exemplary audio processing device, in accordance with an embodiment of the invention.

FIG. 3 is block diagram illustrating a vibration processing path of an audio processing device, in accordance with an embodiment of the invention.

FIG. 4 is a block diagram illustrating details of an exemplary sample rate converter for up-converting audio signals to drive a vibration transducer, in accordance with an embodiment of the invention.

FIG. 5 is a block diagram illustrating operation of a repeater block for processing audio signals to drive a vibration transducer, in accordance with an embodiment of the invention.

FIG. 6 is a flowchart illustrating exemplary steps for generating vibrations based on an audio signal, in accordance with an embodiment of the invention.

### DETAILED DESCRIPTION OF THE INVENTION

Certain aspects of the invention may be found in a method and system for processing audio signals for handset vibration. In various embodiments of the invention, an electronic device may control vibrations generated by a vibration transducer based on audio signals processed by the electronic device. The vibration transducer may be started and/or stopped based on the audio signal. For example, the vibration transducer may be controlled based on a rhythm and/or tempo of the audio signal and/or a content type of the audio signal. Exemplary content types comprise musical content, ringtones, vocal content, and continuous wave tones. The electronic device may control a pattern and/or a frequency at which the transducer is started and/or stopped based on the audio signal. An intensity of generated vibrations may be varied based on the audio signal. A duration of the generated vibrations may be controlled based on the audio signal. The vibration transducer may be controlled based on an event occurring on the electronic device that triggered the processing of the audio signal. Exemplary events comprise calendar reminders, low battery notifications, received signal strength notifications, incoming calls, alerts, warnings, and incoming messages. In various embodiments of the invention, the vibration transducer may be controlled via an audio CODEC within the electronic device.

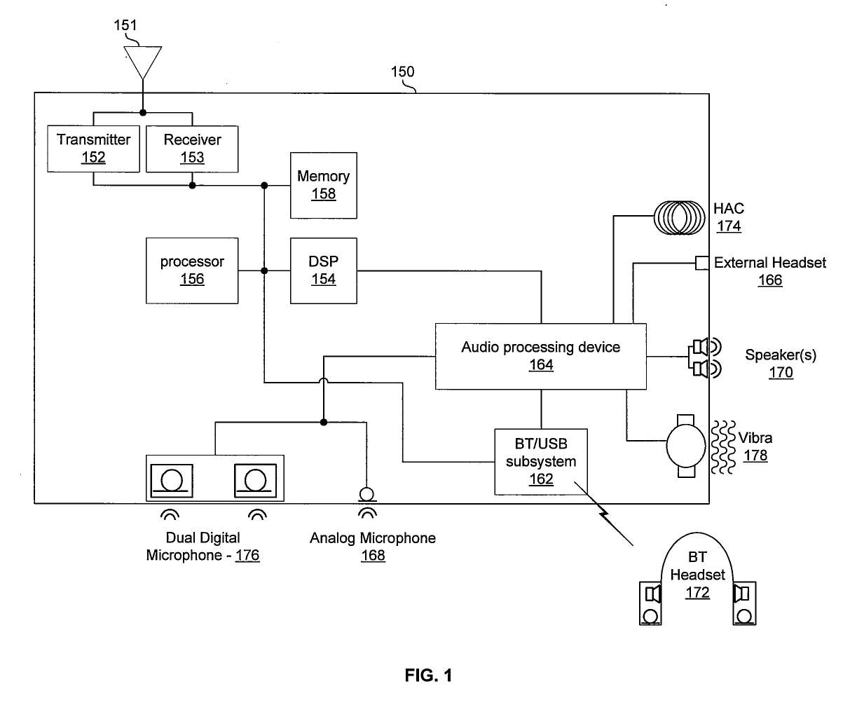

FIG. 1 is a block diagram of an exemplary wireless system, which may be utilized in accordance with an embodiment of the invention. Referring to FIG. 1, the wireless system 150 may comprise an antenna 151, a transmitter 152, a receiver 153, a digital signal processor 154, a processor 156, a memory 158, a Bluetooth (BT) and/or USB subsystem 162, an audio processing device 164, an external headset port 166, an analog microphone 168, speaker(s) 170, a Bluetooth headset 172, a hearing aid compatibility (HAC) coil 174, a dual digital microphone 176, and a vibration transducer 178. The antenna 151 may be used for reception and/or transmission of RF signals. Different wireless systems may use different antennas for transmission and reception.

The transmitter 152 may comprise suitable logic, circuitry, and/or code operable to modulate and up-convert baseband signals to RF signals for transmission by one or more antennas, which may be represented generically by the antenna 151. The transmitter 152 may be operable to execute other functions, for example, filtering the baseband and/or RF signals, and/or amplifying the baseband and/or RF signals. Although a single transmitter 152 is shown, the invention is not so limited. Accordingly, there may be a plurality of transmitters and/or receivers. In this regard, the plurality of transmitters may enable the wireless system 150 to handle a plurality of wireless protocols and/or standards including cellular, wireless local area networking (WLAN), and personal area networking (PAN). In addition, the transmitter 152 may be combined with the receiver 153 and implemented as a combined transmitter and receiver (transceiver).

The receiver 153 may comprise suitable logic, circuitry, and/or code operable to down-convert and demodulate received RF signals to baseband signals. The RF signals may be received by one or more antennas, which may be represented generically by the antenna 151. The receiver 153 may be operable to execute other functions, for example, filtering the baseband and/or RF signals, and/or amplifying the baseband and/or RF signals. Although a single receiver 153 is shown, the invention is not so limited. Accordingly, there may be a plurality of receivers. In this regard, the plurality of receivers may enable the wireless system 150 to handle a plurality of wireless protocols and/or standards including cellular, WLAN, and PAN. In addition, the receiver 153 may be implemented as a combined transmitter and a separate receiver (transceiver).

The DSP 154 may comprise suitable logic, circuitry, and/or code operable to process audio signals. In various embodiments of the invention, the DSP 154 may encode, decode, modulate, demodulate, encrypt, and/or decrypt audio signals. In this regard, the DSP 154 may be operable to perform computationally intensive processing of audio signals.

The processor 156 may comprise suitable logic, circuitry, and/or code operable to configure and/or control one or more portions of the system 150, control data transfers between portions of the system 150, and/or otherwise process data. Control and/or data information may be transferred between the processor 156 and one or more of the transmitter 152, the receiver 153, the DSP 154, the memory 158, the audio processing device 164, and the BT and/or USB subsystem 162. The processor 156 may be utilized to update and/or modify programmable parameters and/or values in one or more of the transmitter 152, the receiver 153, the DSP 154, the memory 158, the audio processing device 164, and the BT and/or USB subsystem 162. In this regard, a portion of the programmable parameters may be stored in the system memory 158. The processor 156 may be any suitable processor or controller. For example, the processor may be a reduced instruction set computing (RISC) microprocessor such as an advanced RISC machine (ARM), advanced virtual RISC (AVR), microprocessor without interlocked pipeline stages (MIPS), or programmable intelligent controller (PIC).

The system memory 158 may comprise suitable logic, circuitry, and/or code operable to store a plurality of control and/or data information, including parameters needed to configure one or more of the transmitter 152, the receiver 153, the DSP 154, and/or the audio processing device 164. The system memory 158 may store at least a portion of the programmable parameters that may be manipulated by the processor 156.

In an exemplary embodiment of the invention, the DSP 154 and processor 156 may exchange audio data and control information via the memory 158. For example, the processor 156 may write encoded audio data, such as MP3 or MC audio, to the memory 158 and the memory may pass the encoded audio data to the DSP 154. Accordingly, the DSP 154 may decode the data and write pulse-code modulated (PCM) audio back into the shared memory for the processor 156 to access and/or to be delivered to the digital portion 211.

The BT and/or USB subsystem 162 may comprise suitable circuitry, logic, and/or code operable to transmit and receive Bluetooth and/or Universal Serial Bus (USB) signals. The BT and/or USB subsystem 162 may be operable to up-convert, down-convert, modulate, demodulate, and/or otherwise process BT and/or USB signals. In this regard, the BT and/or USB subsystem 162 may handle reception and/or transmission of BT and/or USB signals via a wireless communication medium and/or handle reception and/or transmission of USB signals via a wireline communication medium. Information and/or data received via a BT and/or USB connection may be communicated between the BT and/or USB subsystem 162 and one or more of the transmitter 152, the receiver 153, the DSP 154, the processor 156, the memory 158, and the audio processing device 164. For example, the BT and/or USB subsystem 162 may extract audio from a received BT and/or USB signal and may convey the audio to other portions of the wireless system 150 via an inter-IC sound (I²S) bus. Information and/or data may be communicated from one or more of the transmitter 152, the receiver 153, the DSP 154, the processor 156, the memory 158, and the audio processing device 164 to the BT and/or USB subsystem 162 for transmission over a BT and/or USB connection. For example, audio signals may be received from other portions of the wireless system 150 via an I²S bus and the audio signal may be transmitted via a BT and/or USB connection. Additionally, control and/or feedback information may be communicated between the BT and/or USB subsystem 162 and one or more of the transmitter 152, the receiver 153, the DSP 154, the processor 156, the memory 158, and the audio processing device 164.

The audio processing device 164 may comprise suitable circuitry, logic, and/or code that may be operable to process audio signals received from and/or communicated to input and/or output devices. The input and/or output devices may be within or communicatively coupled to the wireless device 150, and may comprise, for example, the analog microphone 168, the stereo speakers 170, the Bluetooth headset 172, the hearing aid compatible (HAC) coil 174, the dual digital microphone 176, and the vibration transducer 178. The audio processing device 164 may up-sample and/or down-sample audio signals to one or more desired sample rates for communication to an audio output device, the DSP 154, and/or the BT and/or USB subsystem 162. In this regard, the audio processing device 164 may also be enabled to handle a plurality of data sampling rate inputs. For example, the audio processing device 164 may accept digital audio signals at sampling rates such as 8 kHz, 11.025 kHz, 12 kHz, 16 kHz, 22.05 kHz, 24 kHz, 32 kHz, 44.1 kHz, and/or 48 kHz. The audio processing device 164 may be enabled to handle a plurality of digital audio inputs of various resolutions, such as 16 or 18-bit resolution, for example. The audio processing device 164 may support mixing of a plurality of audio sources. For example, the audio processing device 164 may support audio sources such as general audio, polyphonic ringer, I²S FM audio, continuous wave (CW) tones, and voice. In an exemplary embodiment of the invention, the general audio and polyphonic ringer sources may support the plurality of sampling rates that the audio processing device 164 may be enabled to accept, while the voice source may support a portion of the plurality of sampling rates, such as 8 kHz and 16 kHz.

The audio processing device 164 may utilize a programmable infinite impulse response (IIR) filter and/or a programmable finite impulse response (FIR) filter for at least a portion of the audio sources to compensate for passband amplitude and phase fluctuation for different input and/or output devices. In this regard, filter coefficients may be configured or programmed dynamically based on operations. Moreover, filter coefficients may all be switched in one-shot or may be switched sequentially, for example. The audio processing device 164 may also utilize a modulator, such as a Delta-Sigma (ΔΣ) modulator, for example, to code digital output signals for analog processing. The audio processing device 164 may be referred to, for example, as an audio coding and/or decoding device or CODEC. In various embodiments of the invention, the audio processing device 164 may be implemented in dedicated hardware.

The external headset port 166 may comprise a physical connection for an external headset to be communicatively coupled to the wireless system 150. The headset may, for example, be an analog headset comprising a microphone and a pair of stereo transducers. Alternatively, the headset may be a digital headset which may utilize a protocol such as USB for communicating audio information.

The analog microphone 168 may comprise suitable circuitry, logic, and/or code operable to detect sound waves and convert them to electrical signals via a piezoelectric effect, for example. The electrical signals generated by the analog microphone 168 may comprise analog signals that may require analog to digital conversion before processing.

The speaker(s) 170 may comprise one or more speakers operable to generate acoustic waves from electrical signals received from the audio processing device 164. In an exemplary embodiment of the invention, there may be a pair of speakers which may be operable to output acoustic waves corresponding to, for example, left and right stereo channels.

The Bluetooth headset 172 may comprise a wireless headset that may be communicatively coupled to the wireless system 150 via the BT and/or USB subsystem 162. In this manner, the wireless system 150 may be operated in a hands-free mode, for example.

The HAC coil 174 may comprise suitable circuitry, logic, and/or code that may enable communication between the wireless device 150 and a hearing aid, for example. In this regard, audio signals may be magnetically coupled from the HAC coil 174 to a coil in a user's hearing aid.

The dual digital microphone 176 may comprise suitable circuitry, logic, and/or code that may detect sound waves and convert them to electrical signals. The electrical signals generated by the dual digital microphone 176 may comprise digital signals, and thus may not require analog to digital conversion prior to digital processing in the audio processing device 164.

The vibration transducer 178 may comprise suitable circuitry, logic, and/or code operable to notify a user of events on the wireless device 150 such as calendar reminders, a low battery notification, a received signal strength notification, an incoming call, and an incoming message without the use of sound. Aspects of the invention may enable the vibration transducer 178 to generate vibrations that may be in synch with, for example, audio signals such as speech, music, ringtones, and/or CW tones.

In operation, audio signals from the receiver 153, the processor 156, and/or the memory 158 may be conveyed to the DSP 154. The DSP 154 may process the signals to generate output baseband audio signals to the audio processing device 164. Additionally, baseband audio signals may be conveyed from the BT and/or USB subsystem 162, the analog microphone 168, and/or the digital microphone 176, to the audio processing device 164.

The audio processing device 164 may process and/or condition one or more of the baseband audio signals to generate one or more signals for controlling the vibration transducer 178. In this regard, the audio processing device 164 may control vibrations based on an audio signal. In this regard, characteristics such as intensity of vibration, a pattern in which vibration is started and stopped, a frequency at which vibration is started and stopped, and/or duration of a vibration or sequence of vibrations may be controlled based on an audio signal processed by the audio processing device 164.

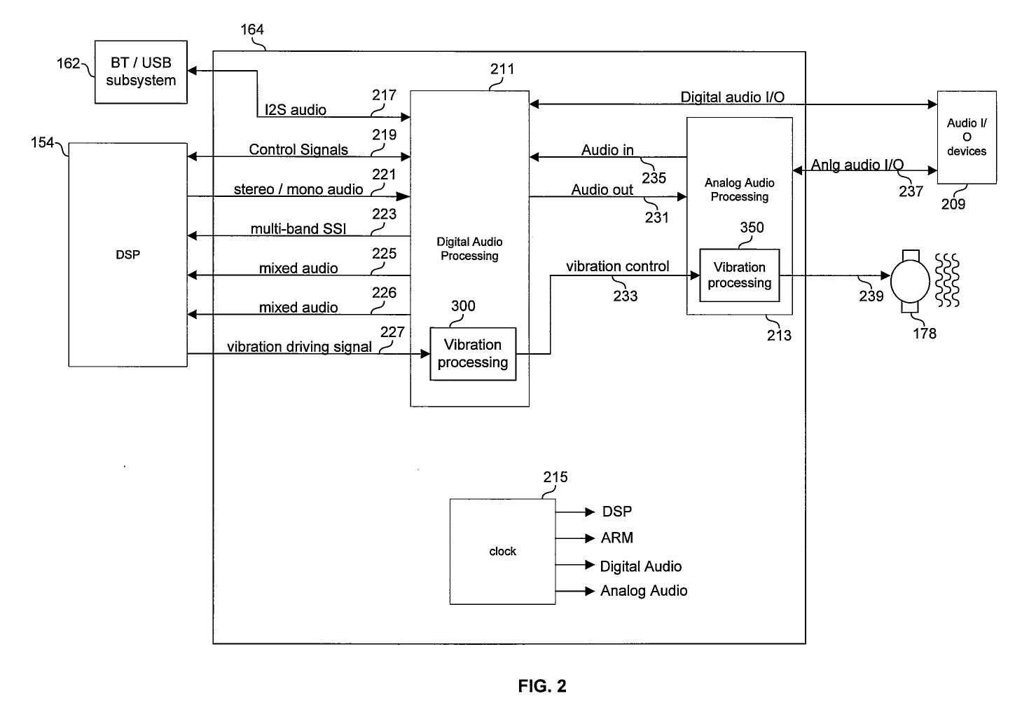

FIG. 2 is a block diagram illustrating an exemplary audio processing device, in accordance with an embodiment of the invention. Referring to FIG. 2, there is shown the DSP 154, the BT and/or USB subsystem 162, the audio processing device 164, and audio input and/or output devices 209. The audio input and/or output devices 209 may comprise one or more devices such as the external headset port 166, the analog microphone 168, the speaker(s) 170, the Bluetooth headset 172, the hearing aid compatibility (HAC) coil 174, the dual digital microphone 176, and the vibration transducer 178 described with respect to FIG. 1. The DSP 154 and the BT and/or USB subsystem 162 may be as described with respect to FIG. 1. The audio processing device 164 may be as described with respect to FIG. 1 and may comprise a digital portion 211, an analog portion 213, and a clock 215.

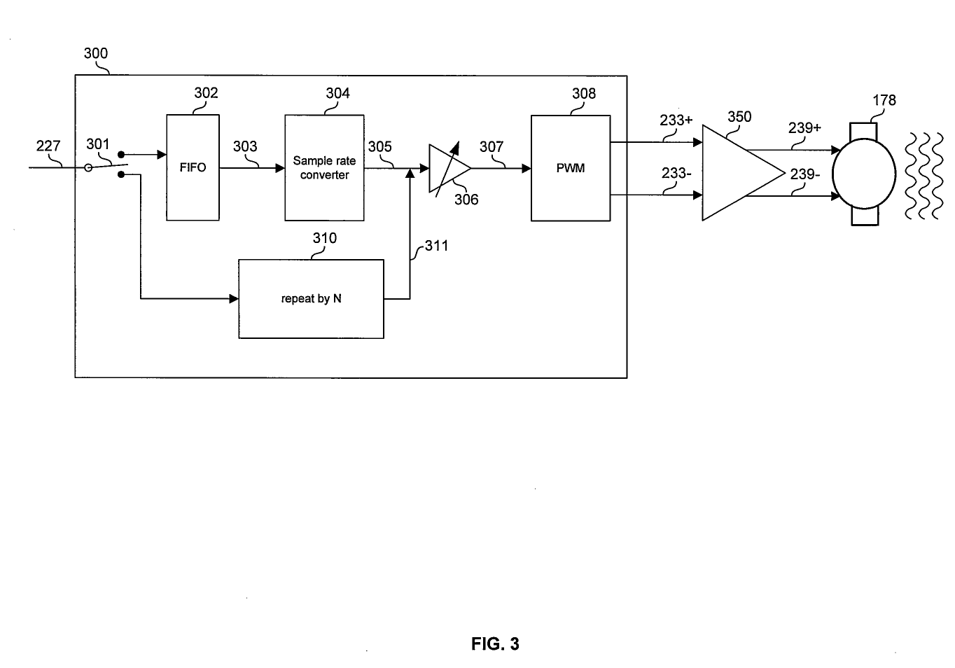

The digital portion 211 may comprise suitable logic, circuitry, and/or code operable to process audio signals in the digital domain. In this regard, the digital portion 211 may be operable to filter, buffer, up-sample, down-sample, apply a digital gain or attenuation to, route, and/or otherwise condition digital audio signals. The digital portion 211 may comprise a digital vibration processing block 300 described below with respect to FIGS. 3, 4, and 5.

The analog portion 213 may comprise suitable logic, circuitry, and/or code operable to convert digital audio signals to an analog representation and amplifying and/or buffering the analog signals for driving audio output devices. The analog portion 211 may comprise an analog vibration processing block 350 described below with respect to FIG. 3.

The clock 215 may comprise suitable logic, circuitry, and/or code operable to generate one or more periodic signals. The clock 215 may, for example, comprise one or more crystal oscillators, phase locked loops (PLLs), and/or direct digital frequency synthesizers (DDFS). The clock 215 may output a plurality of signals each with a distinct frequency and/or phase. The signals output by the clock 215 may be conveyed to one or more of the digital portion 211, the analog portion 213, the DSP 154, the memory 158, and/or the processor 156.

In various exemplary embodiments of the invention, one or more audio signal(s) 217 may be communicated between the digital portion 211 and the BT and/or USB subsystem 162 via an inter-IC sound (I²S) bus. Each of the audio signal(s) 217 may be a monaural channel, a left stereo channel, or a right stereo channel. In an exemplary embodiment of the invention, the BT and/or USB subsystem 162 may be enabled to receive FM broadcast radio and thus two signals 217 comprising left and right channels of FM radio data may be conveyed to the digital portion 211 via an I²S bus.

In various exemplary embodiments of the invention, one or more control signals 219, one or more audio signals 221, one or more SSI signals 223, one or more mixed audio signals 225 and/or 226, and one or more signals 227 for driving a vibration transducer may be communicated between the DSP 154 and the digital portion 211. Monaural and/or stereo audio data may be extracted from RF signals received by the receiver 153 and processed by the DSP block 154 before being conveyed to the digital portion 211 of the processing device 164. One or more signals communicated between the DSP 154 and the digital portion 211 may be buffered. For example, voice signals may not be buffered while music and/or ringtone signals may be written to a first-in-first-out (FIFO) buffer by the DSP 154 and then fetched from the FIFO by the digital portion 211.

The control signal(s) 219 may configure operations of the digital portion 211 based, for example, on a resolution and/or sampling rate of signals being output by the DSP 154. In various embodiments of the invention, one or more control registers for the digital portion 211 may reside in the DSP 154. In various embodiments of the invention, the control signals 219 may comprise one or more interrupt signals.

The audio signal(s) 221 may each comprise, for example, voice data, music data, or ringtone data. Each audio signal 221 may be monaural signal, a left stereo channel, or a right audio channel. The digital portion 211 may condition and/or process the audio signals(s) 221 for conveyance to one or more audio output devices and/or uplink paths. In various embodiments of the invention, the resolution and/or sample rate of the audio signal(s) 221 may vary. Exemplary resolutions may comprise 16-bit and 18-bit resolution. Exemplary sample rates may comprise 8 kHz, 11.05 kHz, 12 kHz, 16 kHz, 22.05 kHz, 24 kHz, 32 kHz, 44.1 kHz, and 48 kHz.

The signal strength indicator (SSI) signals 223 may comprise one or more feedback signals from the digital portion 211 to the DSP 154. The SSI signals 223 may provide an indication of signal strength of one or more frequency bands of one or more audio signals 221, 225, and/or 226. The SSI signals 223 may, for example, be utilized by the DSP 154, the processor 156, the memory 158, or a combination thereof to control a digital gain factor applied to each sub-band of one or more audio signals 221, 225, and/or 226.

The signal 227 may comprise audio data utilized to control a vibration transducer 178. The signal 227 may comprise, for example, CW tone data, voice data, music data, or ringtone data. Characteristics such as intensity of vibration, a pattern in which vibration is started and stopped, a frequency at which vibration is started and stopped, and duration of a vibration or sequence of vibrations may be controlled based on the signal 227.

The mixed audio signal(s) 225 and the mixed audio signals 226 may be output by the digital portion 211 to the DSP 154. The mixed audio signal(s) 225 may each be a composite signal comprising information from one or more monaural signals and/or stereo audio signals. Similarly, the mixed audio signal(s) 226 may each be a composite signal comprising information from one or more monaural signals and/or stereo audio signals. In this regard, one or more of the audio signals 221, one or more of the input audio signals 235, one or more of the input audio signals 241, and/or one or more of the audio signals 217 may be mixed together. Each of the audio signals 221, 235, 241, and 217 may be, for example, amplified, attenuated, band limited, up-converted, down-converted or otherwise processed and/or conditioned prior to mixing. The mixed audio signal(s) 225 may be part of and/or coupled to an uplink path. For example, the signal(s) 225 may be processed by the DSP 154 and transmitted, via the BT and/or USB subsystem 162, to a remote wireless system. Similarly, the mixed audio signal(s) 226 may be part of and/or coupled to an uplink path. For example, the signal(s) 226 may be processed by the DSP 154 and transmitted, via the transmitter 152, to a far-end communication partner or a remote wireless system.

In various exemplary embodiments of the invention, output audio signal(s) 231, vibration control 233, and input audio signal(s) 235 may be communicated between the digital portion 211 and the analog portion 213.

The output audio signal(s) 231 may comprise one or more digital audio signals which have been suitably processed and/or conditioned by the digital portion 211 for output via one or more of the audio output devices 209. Each of the audio signal(s) 231 may be a monaural channel, a left stereo channel, or a right stereo channel. Each of the output audio signal(s) 231 may be converted to an analog representation and amplified by the analog portion 213.

The input audio signal(s) 235 and 241 from an audio input device 209 may comprise one or more digital audio signals to be processed by the digital portion 211. The input audio signal(s) 235 and/or 241 may comprise monaural and/or stereo audio data which the digital portion 211 may process for conveyance to the DSP 154 and subsequent transmission to a remote wireless device. The input audio signal(s) 235 and/or 241 may comprise monaural and/or stereo audio data which the digital portion 211 may process in a “loopback” path for conveyance to one or more audio output devices 209.

The vibration control signal 233 may be pulse width modulated square wave that may, after being amplified by the analog vibration processing block 350, control vibration of the vibration transducer 178. In various exemplary embodiments of the invention, spectral shaping techniques may be applied in the pulse width modulation function, after the analog vibration processing block 350, to reduce noise in the audible band.

In operation, a vibration driving signal 227 comprising audio data may be conveyed from the DSP 154 to the digital vibration processing block 300 in the digital portion 211 of the audio processing device 164. In the digital vibration processing block 300, the signal 227 may be conditioned and utilized to generate the signal 233. The signal 233 may be conveyed from the digital vibration processing block 300 to the analog vibration processing block 350 in the analog portion 213 of the audio processing device 164. The analog vibration processing block 350 may amplify and/or buffer the signal 233 to generate the vibration output signal 239.

FIG. 3 is a block diagram illustrating a vibration processing path of an audio processing device, in accordance with an embodiment of the invention. Referring to FIG. 3, there is shown a digital vibration processing block 300 comprising a FIFO 302, a sample rate converter 304, a digital gain block 306, a pulse width modulator (PWM) 308, and a sample repeater 310. There is also shown an analog vibration processing block 350.

The FIFO 302 may comprise suitable logic, circuitry, and/or code operable to buffer audio data. In this regard, the FIFO 302 may comprise one or more memory elements.

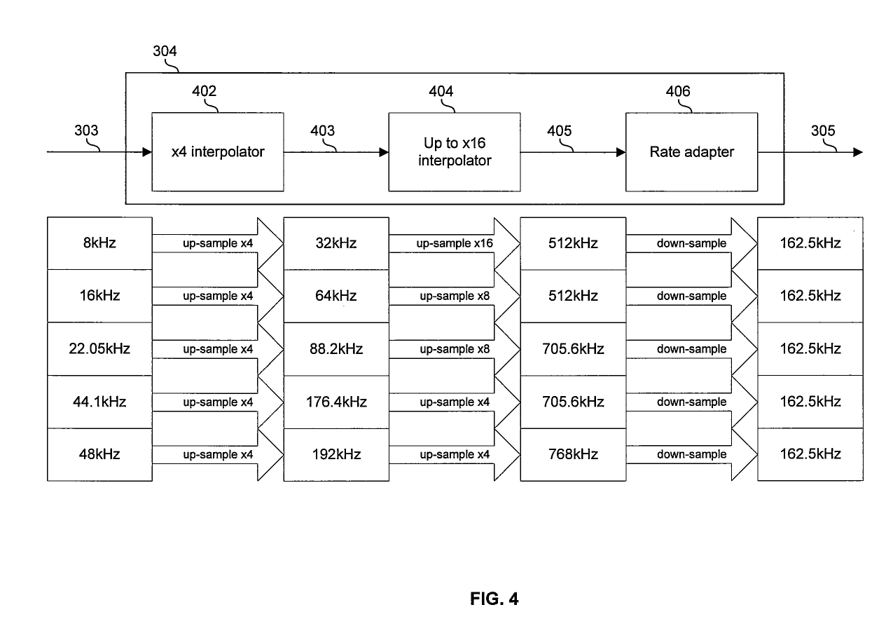

The sample rate converter 304 may comprise suitable logic, circuitry, and/or code operable to up-sample the signal 227 to a frequency suitable for driving the PWM 308. In an exemplary embodiment of the invention, audio signals may be up-sampled to 162.5 kHz for driving the PWM 308. Additional details of the sample rate converter are described below with respect to FIG. 4.

The digital gain block 306 may comprise suitable logic, circuitry, and/or code operable to adjust an amplitude and/or intensity of digital audio signal 307. In this regard, the signal 307 may be a scaled version of the signal 305 or 311. The digital gain block 306 may be configured via one or more control signals from, for example, the processor 156, the DSP 154, and/or the memory 158. In this regard, the digital gain block 306 may be configured dynamically and/or in real-time.

The PWM 308 may comprise suitable logic, circuitry, and/or code operable to generate a periodic differential signal 233 wherein a duty cycle of the signal 233 is based on the audio signal 227. The PWM 308 may be configured via one or more control signals from, for example, the processor 156, the DSP 154, and/or the memory 158. In an exemplary embodiment of the invention, the PWM 308 may be a class D modulator which may pulse width modulate an approximately 722 kHz square wave by a 162.5 kHz input signal.

The sample repeater 310 may comprise suitable logic, circuitry, and/or code operable to up-sample the signal 227 by repeating samples of the signal 227 ‘N’ times. In this regard, ‘N’ may be variable and may be determined based on the sample frequency of the signal 227.

The analog vibration processing block 350 may comprise suitable logic, circuitry, and/or code operable to amplify and/or buffer the signal 233 for driving the vibration transducer 178. In this regard, driving the vibration transducer 178 may require more current than the PWM 308 may be able to output and thus the analog vibration processing block 350 may provide increased output current for driving the vibration transducer 178.

In operation, the switch 301 may be configured based on the content of the signal 227. In instances that the signal 227 comprises non-audio band values; the switch 301 may be configured to route the signal 227 to the sample repeater 310. For example, sample values of signal 227 change at a rate of a few Hertz or less, or the vibrator driving signal may be a pre-defined amplitude pattern.

In instances that the signal 227 comprises audio data, the switch 301 may be configured to route the signal 227 to the FIFO 302 where it may be buffered. Subsequently, audio data from the FIFO 302 may be conveyed to the sample rate converter 304 which may up-sample the signal 303 to a sample rate suitable for driving the PWM 308. The output 305 of the sample rate converter 304 may be conveyed to the digital gain block 306. The gain block 306 may scale the audio signal 305 to output the signal 307 to the PWM 308. The PWM 308 may adjust the duty cycle of the periodic signal 233 based on the amplitude of the audio signal 307. Spectral shaping techniques may be applied during PWM duty cycle adjustment to reduce noise in the audible band. The analog vibration processing block 350 may buffer and/or amplify the signal 233 to generate the vibration output 239. Accordingly, vibration output 239 may be a high current, pulse width modulated signal capable of driving the vibration transducer 178. In this regard, vibration may start when an absolute value of the voltage of the signal 239 goes above a threshold and vibration may stop when an absolute value of the voltage on the signal 239 goes below a threshold. Vibration intensity may be determined by the duty cycle of the signal 239. Additionally, polarity of the voltage on the signal 239 may determine a direction in which the vibration transducer spins. Thus, by switching the polarity of the signal 239, vibrations may be rapidly started and stopped.

In various exemplary embodiments of the invention, vibration may be started and stopped in synch with the rhythm or tempo of audio data in the signal 227. Exemplary audio data may comprise voice, music, musical notes and/or musical tones, In various exemplary embodiments of the invention, intensity of vibration may be varied in synch with the rhythm or tempo of audio data in the signal 227. In various exemplary embodiments of the invention, audio data in the signal 227 may be a sequence of CW tones which may be encoded (e.g., Morse code) and vibration may be started and stopped in synch with the CW tones. In various exemplary embodiments of the invention, vibration may be started and stopped based on a type of audio content in the signal 227. In various exemplary embodiments of the invention, intensity of vibration may be varied based on a type of audio content in the signal 227. Exemplary content types may comprise continuous wave (CW) tone, music, ringtone, and voice.

FIG. 4 is a block diagram illustrating details of an exemplary sample rate converter for up-converting audio signals to drive a vibration transducer, in accordance with an embodiment of the invention. Referring to FIG. 4 the sample rate converter 304 may comprise an interpolator 402, an interpolator 404, and a rate adapter 406.

The interpolator 402 may comprise suitable logic, circuitry, and/or code operable to up-sample a signal by a factor of 4. In this regard, the signal 303 input to the interpolator 402 may be up-sampled by a factor of 4 to generate the signal 403. In an exemplary embodiment of the invention, the interpolator 402 may comprise an IIR filter. The IIR filter may be a 10-th order elliptic filter with cut-off frequency set at 0.4535*Fs, passband ripple 0.1 dB, and stopband attenuation 70 dB, where Fs is the sampling frequency of the signal 303. The IIR filter may be implemented utilizing five biquads with fixed and/or programmable coefficients. In various exemplary embodiments of the invention, a signal 303 having sampling frequency 8 kHz, 16 kHz, 22.05 kHz, 44.1 kHz, 48 kHz may be up-sampled to a signal 305 having frequency 32 kHz, 64 kHz, 88.2 kHz, 176.4 kHz, and 192 kHz, respectively.

The interpolator 404 may comprise suitable logic, circuitry, and/or code operable to up-sample a signal by a variable up-sampling factor R. In this regard, the signal 305 input to the interpolator 404 may be up-sampled by a factor of up to sixteen to generate the signal 405. In an exemplary embodiment of the invention, the interpolator 404 may be a five-section cascaded integrate-comb (CIC) interpolator with up-sampling factor of 4, 8, or 16. In various exemplary embodiments of the invention, a signal 403 having sampling frequency 32 kHz, 64 kHz, 88.2 kHz, 176.4 kHz, and 192 kHz, may be up-sampled to a signal 405 having sampling frequency 512 kHz, 512 kHz, 705.6 kHz, 705.6 kHz, and 768 kHz, respectively.

The rate adapter 406 may comprise suitable logic, circuitry, and/or code operable to down-sample signals. In this regard, the signal 405 may be down-sampled to a signal 305 having sample frequency of 162.5 kHz. The rate adapter may be enabled to handle a variety of input frequencies. For example, the signal 405 may have a sample frequency of 512 kHz, 705.6 kHz, or 768 kHz.

In operation, the interpolator 402 may insert 3 zero values between adjacent samples of the input signal 303 and filter the resulting signal to generate the signal 403. The signal 403 may be gain-adjusted by a factor of 4 to compensate for the gain loss due to zero-insertion. The signal 403 input to the interpolator 404 may be comb filtered and up-sampled by inserting R-1 zeros, and then integrated to output the signal 405, where R is the up-sampling factor. The signal 405 may then be down-sampled to 162.5 kHz

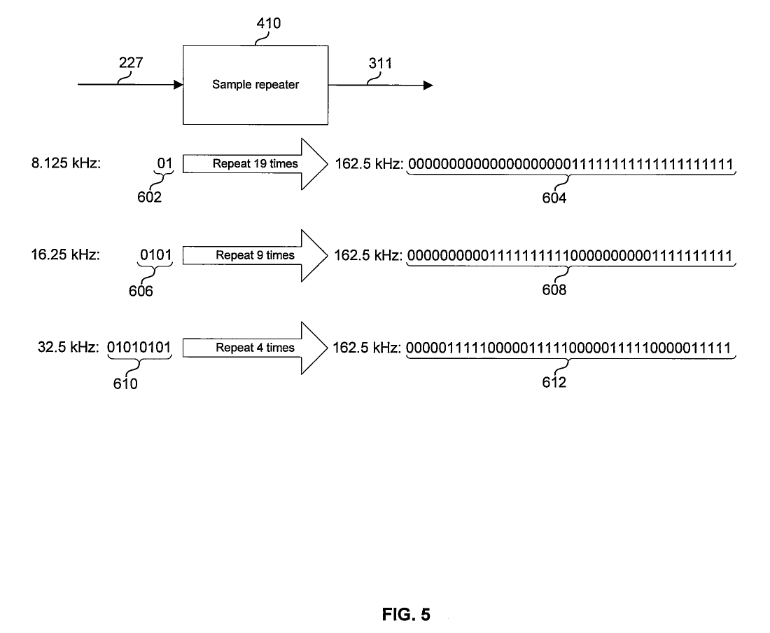

FIG. 5 is a block diagram illustrating operation of a repeat N block for processing audio signals to drive a vibration transducer, in accordance with an embodiment of the invention. Referring to FIG. 5 there is shown input data sequences 602, 606, and 610, and corresponding output data sequences 604, 608, and 612. Although 1-bit samples are used for illustration, the invention is not so limited. In this regard, in various exemplary embodiments of the invention, the signals 227 and 311 may comprise 23-bit samples.

In an exemplary embodiment of the invention, the input signal 227 may have a sample frequency of 8.125 kHz. In such instances, input samples may be repeated 19 times. In this regard, the input sequence 602 on signal 227 may result in the sequence 604 on the signal 311.

In another exemplary embodiment of the invention, the input signal 227 may have a sample frequency of 16.25 kHz. In such instances, input samples may be repeated 9 times. In this regard, the input sequence 606 on signal 227 may result in the sequence 608 on the signal 311.

In another exemplary embodiment of the invention, the input signal 227 may have a sample frequency of 32.5 kHz. In such instances, input samples may be repeated 4 times. In this regard, the input sequence 610 on signal 227 may result in the sequence 612 on the signal 311.

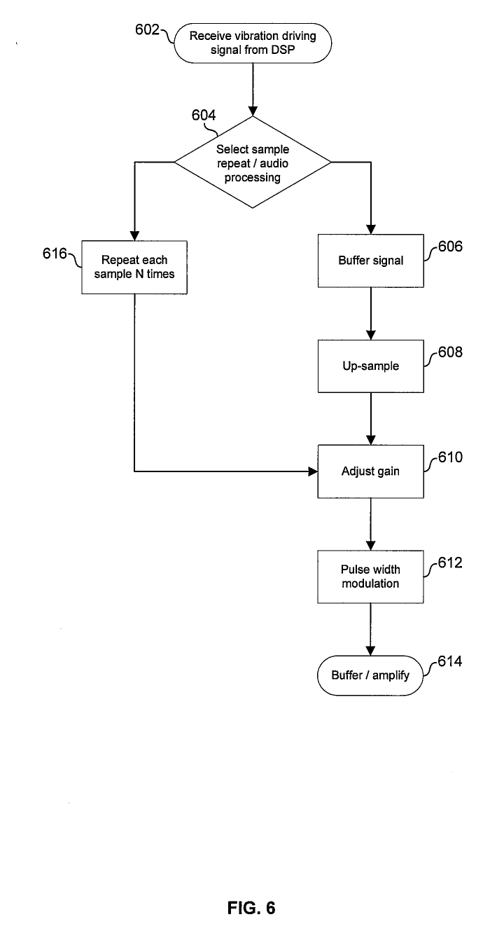

FIG. 6 is a flowchart illustrating exemplary steps for generating vibrations based on an audio signal, in accordance with an embodiment of the invention. Referring to FIG. 6 the exemplary steps may begin with step 602 when a vibration driving signal 227 is received by the audio processing device 164 from the DSP 154. Subsequent to step 602, the exemplary steps may advance to step 604. In step 604, the switching element 301 may be configured based on whether the signal 227 comprises audio data. In instances that the signal 227 comprises audio data, the switch 301 may communicatively coupled the signal 227 to the FIFO 302 and the exemplary steps may advance to step 606.

In step 606, the signal 227 may be buffered by the FIFO 302. Subsequent to step 606, the exemplary steps may advance to step 608. In step 608, the audio signal may be up-sampled to a sample rate compatible with the PWM 308 and/or the vibration transducer 178. Subsequent to step 608, the exemplary steps may advance to step 610. In step 610, levels of the up-sampled signal may be adjusted via the digital gain block 306. Subsequent to step 610, the exemplary steps may advance to step 612. In step 612, the PWM 308 may control the duty cycle of a square wave based on the gain adjusted signal output by the digital gain block 306. In this regard, spectral shaping may be applied during PWM processing. Subsequent to step 612, the exemplary steps may advance to step 614. In step 614, the square wave output by the PWM 308 may be buffered and/or amplified such that it may be of sufficient strength to drive the vibration transducer 178.

Returning to step 604, in instances that the signal 227 comprises static or semi-static data, the switch 301 may communicatively couple the signal 227 to the sample repeater 310 and the exemplary steps may advance to step 616. In step 616, the sample repeater 310 may repeat each sample of the signal 227 ‘N’ times, where N may be determined based on the sample rate of the signal 227. Subsequent to step 616, the exemplary steps may advance to the previously described step 610.

Thus, exemplary aspects of a method and system for processing audio signals for handset vibration are provided. In this regard, an electronic device 150 may control vibrations generated by a vibration transducer 178 based on audio signals processed by the electronic device 150. The vibration transducer 178 may be started and/or stopped based on the signal 227. For example, the vibration transducer 178 may be controlled based on a rhythm and/or tempo of the audio signal 227 and/or a content type of the audio signal 227. Exemplary content types comprise musical content, ringtones, vocal content, and continuous wave tones. The electronic device 150 may control a pattern and/or a frequency at which the transducer 178 may be started and/or stopped based on the audio signal 227. An intensity of generated vibrations may be varied based on the audio signal 227. A duration of the generated vibrations may be controlled based on the audio signal 227. The vibration transducer 178 may be controlled based on an event occurring on the electronic device that triggered the processing of the audio signal. Exemplary events comprise calendar reminders, low battery notifications, received signal strength notifications, incoming calls, alerts, warnings, and incoming messages. In various embodiments of the invention, the vibration transducer may be controlled via an audio CODEC within the electronic device.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for processing audio signals for handset vibration.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. One embodiment may utilize a commercially available processor, which may be implemented external to an ASIC implementation of the present system. Alternatively, in an embodiment where the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for signal processing, the method comprising:
controlling a vibration transducer communicatively coupled to an electronic device based on an audio signal processed by said electronic device to generate vibrations.

2. The method according to claim 1, comprising varying an intensity of said generated vibrations based on said audio signal.

3. The method according to claim 1, comprising starting and/or stopping said vibration transducer based on said audio signal.

4. The method according to claim 3, comprising controlling a pattern of said starting and stopping of said vibration transducer based on said audio signal.

5. The method according to claim 3, comprising controlling a frequency of said starting and stopping of said vibration transducer based on said audio signal.

6. The method according to claim 1, comprising controlling a duration of said generated vibrations based on said audio signal.

7. The method according to claim 1, comprising controlling said vibration transducer based on a rhythm and/or tempo of said audio signal.

8. The method according to claim 1, comprising controlling said vibration transducer based on a content type of said audio signal.

9. The method according to claim 8, wherein said content type comprises one or more of musical content, a ringtone, vocal content, and a continuous wave tone.

10. The method according to claim 1, comprising controlling said vibration transducer based on an event on said electronic device triggering said processing of audio signal.

11. The method according to claim 10, wherein said event comprises one or more of a calendar reminder, a low battery notification, a received signal strength notification, an incoming call, an alert, a warning, and an incoming message.

12. The method according to claim 1, comprising controlling said vibration transducer via a hardware audio CODEC within said electronic device.

13. A system for audio signal processing, the system comprising:
one or more circuits in an electronic device, said one or more circuits being operable to control a vibration transducer communicatively coupled to said electronic device based on an audio signal processed by said electronic device to generate vibrations.

14. The system according to claim 13, wherein said one or more circuits are operable to vary an intensity of said generated vibrations based on said audio signal.

15. The system according to claim 13, wherein said one or more circuits are operable to start and/or stop said vibration transducer based on said audio signal.

16. The system according to claim 15, wherein said one or more circuits are operable to control a pattern of said starting and stopping of said vibration transducer based on said audio signal.

17. The system according to claim 15, wherein said one or more circuits are operable to control a frequency of said starting and stopping of said vibration transducer based on said audio signal.

18. The system according to claim 13, wherein said one or more circuits are operable to control a duration of said generated vibrations based on said audio signal.

19. The system according to claim 13, wherein said one or more circuits are operable to control said vibration transducer based on a rhythm and/or tempo of said audio signal.

20. The system according to claim 13, wherein said one or more circuits are operable to control said vibration transducer based on a content type of said audio signal.

21. The system according to claim 20, wherein said content type comprises one or more of musical content, a ringtone, vocal content, and a continuous wave tone.

22. The system according to claim 13, wherein said one or more circuits are operable to control said vibration transducer based on an event on said electronic device triggering said processing of audio signal.

23. The system according to claim 22, wherein said event comprises one or more of a calendar reminder, a low battery notification, a received signal strength notification, an incoming call, an alert, a warning, and an incoming message.

24. The system according to claim 13, wherein said one or more circuits are operable to control said vibration transducer via a hardware audio CODEC within said electronic device
